(19) United States
(12) Patent Application Publication
(10) Pub. No.: US 2007/0051215 A1
(43) Pub. Date: Mar. 8, 2007

(54) Screwdriver shank having a non-slip tip

(76) Inventor: David M. Petillo, Ocean, NJ (US)

Correspondence Address: MICHAEL B. EINSCHLAG, ESQ., 25680 FERNHILL DRIVE, LOS ALTOS HILLS, CA, 94024, US

(21) Appl. No.: 11/517,183

(22) Filed: Sep. 7, 2006

Related U.S. Application Data
(60) Provisional application No. 60/715,386, filed on Sep. 8, 2005.

(51) Int. Cl. B25B 23/00; B25B 15/00; B25B 23/10; B25B 23/08

(52) U.S. Cl. 81/436; 81/452

(57) ABSTRACT

One embodiment of the present invention is a screwdriver shank having a non-slip tip disposed at an end of the shank wherein: (a) a distal end of the tip is adapted to fit into a slot having a predetermined width; and (b) an edge of the tip, along the distal end, comprises two or more straight line segments wherein two of the line segments are disposed at non-zero angles with respect to each other.

This patent application relates to U.S. Provisional Application No. 60/715,386 filed Sep. 8, 2005, from which priority is claimed under 35 USC §119(e), and which provisional application is incorporated herein in its entirety.

### TECHNICAL FIELD OF THE INVENTION

One or more embodiments of the present invention pertain to screwdriver shanks having a non-slip tip.

### BACKGROUND OF THE INVENTION

A conventional screwdriver tip is a straight, rectangular, flat blade. Whenever torque is applied to a screwdriver having such a conventional tip, the end of the blade can slip out of either side of a slot in a screw head, potentially causing damage to a finished work surface and/or to the screw head. This problem is caused by an inability to keep the screw driver blade from moving out of the slot in the screw head.

In light of the above, there is a need in the art for a screwdriver apparatus that solves one or more of the above-identified problems.

### SUMMARY OF THE INVENTION

One or more embodiments of the present invention satisfy one or more of the above-identified problems in the art. In particular, one embodiment of the present invention is a screwdriver shank having a non-slip tip disposed at an end of the shank wherein: (a) a distal end of the tip is adapted to fit into a slot having a predetermined width; and (b) an edge of the tip, along the distal end, comprises two or more straight line segments wherein two of the line segments are disposed at non-zero angles with respect to each other.

### BRIEF DESCRIPTION OF THE DRAWING

FIG. 1 shows a side view of a screwdriver shank that is fabricated in accordance with one or more embodiments of the present invention;

FIG. 2 shows a top view of a screwdriver shank that is fabricated in accordance with one or more embodiments of the present invention, which screwdriver shank has a four-point-contact tip, and which screwdriver shank is inserted into a screwdriver grip handle;

FIG. 3 shows a top view of a screwdriver shank that is fabricated in accordance with one or more embodiments of the present invention, which screwdriver shank has a two-point-contact tip, and which screwdriver shank is inserted into a screwdriver grip handle;

FIG. 4 shows a top view of a screw head having a slot, wherein a four-point-contact tip of a screwdriver shank that is fabricated in accordance with one or more embodiments of the present invention has been inserted into the slot—the four-point-contact tip is shown as having been cut off in a plane parallel to a top of the screw head;

FIG. 5 shows a side view of a wood screw having a slot, wherein a tip of a screwdriver shank having a two-point-contact tip that is fabricated in accordance with one or more embodiments of the present invention has been inserted into the slot;

FIG. 6 shows a top view of a screw head having a slot, wherein a two-point-contact tip of a screwdriver shank that is fabricated in accordance with one or more embodiments of the present invention has been inserted into the slot—the two-point-contact tip is shown as having been cut off in a plane parallel to a top of the screw head;

FIGS. 7A-7D and 7F-7Q show a side view of screwdriver shanks that are fabricated in accordance with one or more embodiments of the present invention to illustrate various embodiments of gripping lines; and

FIG. 7E shows a side view of a prior art screwdriver shank.

### DETAILED DESCRIPTION

A screwdriver shank having a non-slip tip that is fabricated in accordance with one or more embodiments of the present invention may be used by professional or amateur craftsmen, and may be produced in a cost-efficient manner. Such a screwdriver shank provides one or more of the following advantages: (a) superior tip-to-screw gripping ability when torque is applied; (b) reduction or elimination of a tip slipping out of a slot in a screw head, screw stripping, damaging screw heads, and damaging finished work surfaces; (c) cost efficient production; (d) use with slotted-head screws and many Phillips-head screws, as well as, use to remove stripped, rusted, or damaged screws; and (e) psychological assurance to a user that damage to finished work surfaces is less of, or no longer, a concern. Further, a screwdriver shank having a non-slip screwdriver tip that is fabricated in accordance with one or more embodiments of the present invention can be used with, for example and without limitation, a screwdriver grip handle, a power drill, a ratchet, a wrench, a drill press, a lathe, a milling machine, and so forth. Still further, a screwdriver shank having a non-slip tip that is fabricated in accordance with one or more embodiments of the present invention may comprise gripping lines (in a variety of patterns and shapes) disposed on one or both sides of the tip.

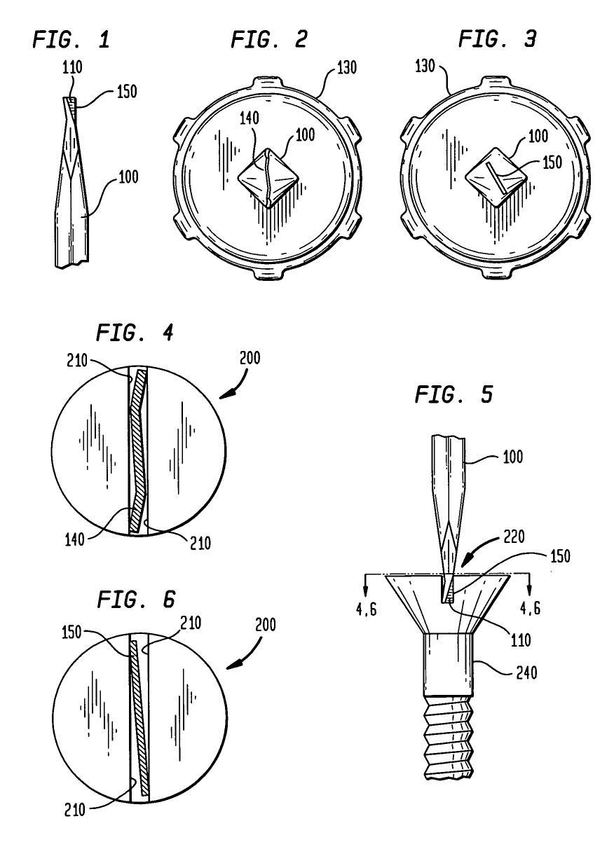

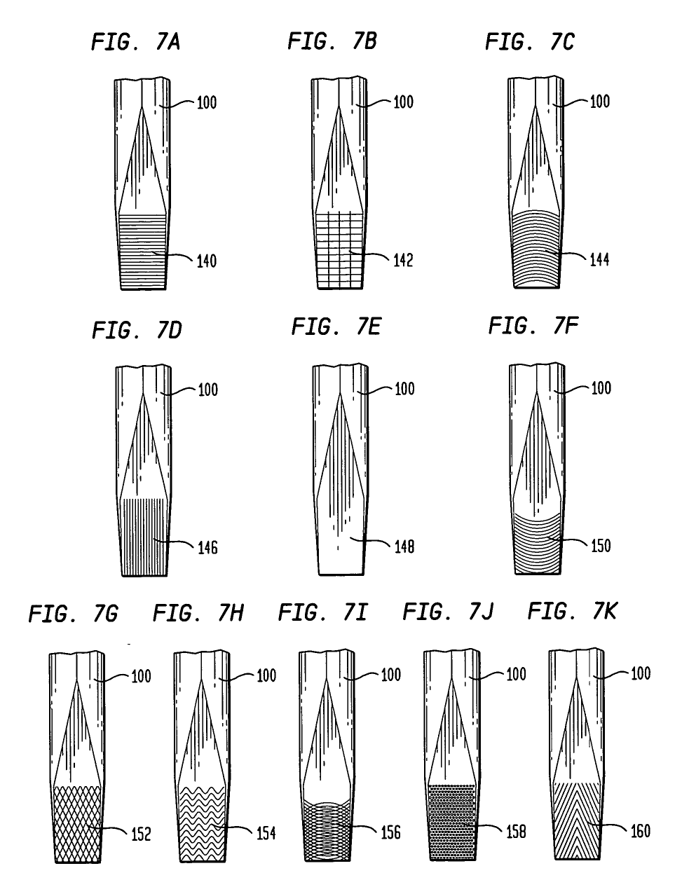

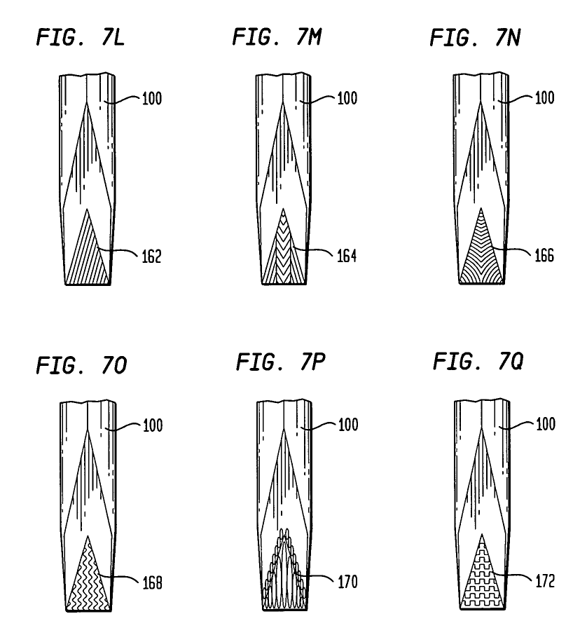

FIG. 1 shows a side view of screwdriver shank 100 that is fabricated in accordance with one or more embodiments of the present invention FIG. 1. As shown in FIG. 1, screwdriver shank 100 includes two-point-contact tip 150. In addition, as further shown in FIG. 1, two-point-contact tip 150 includes gripping lines 110. Advantageously, in accordance with one or more embodiments of the present invention, gripping lines 110 provide extra non-slip ability (various embodiments of gripping lines 110 will be described below in conjunction with FIGS. 7A-7D and 7F-7Q).

FIG. 3 shows a top view of screwdriver shank 100 that is fabricated in accordance with one or more embodiments of the present invention. As shown in FIG. 3, screwdriver shank 100 narrows down toward, and includes, two-point-contact tip 150. As will be described below in conjunction with FIG. 6, a distal end of two-point-contact tip 150 can be disposed to a predetermined depth between two planes spaced a predetermined distance apart (i.e., it can be inserted into a slot in a head of a screw having a predetermined width). As further shown in FIG. 3, in accordance with one or more embodiments of the present invention, screwdriver shank 100 is inserted into screwdriver grip handle 130. As one can appreciate from FIG. 1 and FIG. 3, a first vertical plane (i.e., a plane perpendicular to the plane of the paper) that includes a distal end of two-point-contact tip 150 is disposed at an angle with respect to a second vertical plane (i.e., a plane perpendicular to the plane of the paper that is parallel to a side edge of the paper) that is along an axis of symmetry of shank 100 through a proximal end of tip 150). In other words, in this sense, the distal end of two-point-contact tip 150 is rotated or twisted with respect to the proximal end of two-point-contact tip 150.

FIG. 2 shows a top view of screwdriver shank 100 that is fabricated in accordance with one or more embodiments of the present invention. As shown in FIG. 2, screwdriver shank 100 narrows down toward, and includes, four-point-contact tip 140. As will be described below in conjunction with FIG. 4, a distal end of two-point-contact tip 150 can be disposed to a predetermined depth between two planes spaced a predetermined distance apart (i.e., it can be inserted into a slot in a head of a screw having a predetermined width). As further shown in FIG. 2, in accordance with one or more embodiments of the present invention, screwdriver shank 100 is inserted into screwdriver grip handle 130. Although the distal end of four-point-contact tip 140 is not shown in FIG. 2 as being rotated or twisted with respect to a proximal end of four-point-contact tip 140, it should be understood by those of ordinary skill in the art that further embodiments of the present invention exist wherein the distal end of four-point-contact tip 140 is thusly rotated or twisted.

FIG. 6 shows a top view of screw head 200 having a slot bounded by walls 210 wherein two-point-contact tip 150 of a screwdriver shank that is fabricated in accordance with one or more embodiments of the present invention has been inserted into the slot (two-point-contact tip 150 is shown as having been cut off in a plane parallel to a top of screw head 200). As shown in FIG. 6, two-point-contact tip 150 is disposed in a position ready to apply a torque to the screw (i.e., it is wedged at two points or at two areas against walls 210 of the slot when a torque is applied).

FIG. 4 shows a top view of screw head 200 having a slot bounded by walls 210 wherein four-point-contact tip 140 of a screwdriver shank that is fabricated in accordance with one or more embodiments of the present invention has been inserted into the slot (four-point-contact tip 140 is shown as having been cut off in a plane parallel to a top of screw head 200). As shown in FIG. 4, four-point-contact tip 140 is disposed in a position ready to apply a torque to the screw (i.e., it is wedged at four points or at four areas against walls 210 of the slot when a torque is applied).

FIG. 5 shows a side view of wood screw 240 having slot 220, wherein two-point-contact tip 150 of screwdriver shank 100 that is fabricated in accordance with one or more embodiments of the present invention has been inserted into slot 220. As further shown in FIG. 5, screwdriver shank 100 includes gripping lines 110 disposed on a surface of two-point-contact tip 150 for extra non-slip ability. As further shown in FIG. 5, two-point-contact tip 150 is disposed in a position ready to apply a torque to screw 240 (i.e., it is wedged against the walls of the slot when a torque is applied).

FIGS. 7A-7D and 7F-7Q show a side view of screwdriver shanks that are fabricated in accordance with one or more embodiments of the present invention with various embodiments of gripping lines, and FIG. 7E shows a side view of a prior art screwdriver shank. In accordance with one or more embodiments of the present inventions, a gripping line is a groove in a surface of the tip, and FIGS. 7A-7D and 7F-7Q show the configuration of the gripping lines on the surface of the tip. Further, in accordance with one or more embodiments of the present inventions, gripping lines are disposed proximal to a distal end of the tip.

FIG. 7A shows a side view of screwdriver shank 100 wherein gripping lines 140 are horizontal, parallel, straight gripping lines; FIG. 7B shows a side view of screwdriver shank 100 wherein gripping lines 142 are a grid of horizontal, parallel and vertical, parallel, straight gripping lines; FIG. 7C shows a side view of screwdriver shank 100 wherein gripping lines 144 are arcs curving downward toward the tip; FIG. 7D shows a side view of screwdriver shank 100 wherein gripping lines 146 are vertical, parallel, straight gripping lines; FIG. 7E shows a side view of prior art screwdriver shank 100; FIG. 7F shows a side view of screwdriver shank 100 wherein gripping lines 150 are arcs curving upward away from the tip; FIG. 7G shows a side view of screwdriver shank 100 wherein gripping lines 152 are a grid of first parallel, straight gripping lines disposed at a first angle to vertical and second parallel, straight gripping lines disposed at a second angle to vertical; FIG. 7H shows a side view of screwdriver shank 100 wherein gripping lines 154 are horizontal, wavy lines; FIG. 71 shows a side view of screwdriver shank 100 wherein gripping lines 156 are overlapping sets of arcs curving upward away from and downward toward the tip, respectively; FIG. 7J shows a side view of screwdriver shank 100 wherein gripping lines 158 are miniature circle gripping lines; FIG. 7K shows a side view of screwdriver shank 100 wherein gripping lines 160 are triangular rip gripping lines; FIG. 7L shows a side view of screwdriver shank 100 wherein gripping lines 162 are triangular gripping lines; FIG. 7M shows a side view of screwdriver shank 100 wherein gripping lines 164 comprise three groups of gripping lines—two groups of matching outside angles with a third group of having inverted triangle centers; FIG. 7N shows a side view of screwdriver shank 100 wherein gripping lines 166 are a pattern of converging curved gripping lines; FIG. 70 shows a side view of screwdriver shank 100 wherein gripping lines 168 include vertical wavy gripping lines; FIG. 7P shows a side view of screwdriver shank 100 wherein gripping lines 170 are a group of distorted oval-shaped gripping lines; and FIG. 7Q shows a side view of screwdriver shank 100 wherein gripping lines 172 comprise square chain gripping lines.

To fabricate a screwdriver shank having a non-slip tip in accordance with one or more embodiments of the present invention, one might utilize materials such as, for example and without limitation, hardened steel, titanium, cobalt, stainless steel, nickel, ceramic, alloyed steel, or any other material that is harder then a screw head to which the screwdriver shank might be applied. It should be keep in mind that a screwdriver shank may come in any number of different sizes for use in any number of different applications such as, for example and without limitation, screwdriver shanks with tips small enough to be useful with miniature watch screws all the way to screwdriver shanks with tips large enough to be useful with screws used on bridges, tunnels, ships, and dams. In addition, for use with plastic or wood screws, the screwdriver shank material might be, for example and without limitation, brass, copper, aluminum, tin, and zinc. In addition, and in accordance with one or more embodiments of the present invention, the length of a tip may vary (depending on a particular application and the thickness and/or width of the tip), for example and without limitation, from 0.001″ to 1.0″ and beyond. In further addition, and in accordance with one or more embodiments of the present invention, the width of a tip width may vary (depending on a particular application and the thickness and/or length of the tip), for example and without limitation, from 0.001″ to 1.0″ and beyond.

In accordance with one or more embodiments of the present invention, a screwdriver shank having a non-slip tip may be fabricated using any one of a number of methods that are well known to those of ordinary skill in the art such as, for example and without limitation, forging, casting, molding, and machining. In addition, one or more embodiments of the screwdriver shank having a non-slip tip may be fabricated by first fabricating the screwdriver shank and tip, and then by rotating or twisting the tip using any one of a number of methods that are well known to those of ordinary skill in the art such as, for example and without limitation, by rotating or twisting the tip in a clamping or bending device while the metal (in an appropriate embodiment) is still pliable. Such embodiments may provide cost efficient production for tool manufacturers by keeping manufacturing the same as for conventional products, and only adding steps at the end of the conventional production line.

Although embodiments have described above having a two-point-contact tip or a four-point-contact tip, those of ordinary skill in the art should readily appreciate that further embodiments exist where, depending on a particular application, any suitable number of points or areas of contact may be fabricated. In addition, it should be understood by one of ordinary skill in the art that further embodiments exist wherein an edge of a non-slip tip, along its distal end, is comprised of: (a) a straight line (for example, like non-slip tip 150 described above); (b) two or more straight line segments wherein two of the line segments are disposed at non-zero angles with respect to each other (for example, like non-slip tip 140 described above; (c) one or more curved segments of various shape; or (d) a combination of straight line segments and curved segments. In addition, as one of ordinary skill in the art can readily appreciate, in accordance with one or more embodiments of the present invention, gripping lines may be disposed on some or all surfaces of a tip, typically surfaces proximal to the distal end of the tip.

In accordance with one or more embodiments of the present invention, gripping lines may be fabricated using any one of a number of methods that are well known to those of ordinary skill in the art such as, for example and without limitation, forging, casting, molding, lasering, stamping, machining, or grinding a desired shape. In accordance with one or more embodiments of the present invention, the length, width, depth, cross-sectional shape of groove, and spacing of the gripping lines may vary (depending on a particular application and the size of the tip), for example and without limitation, from 0.001″ to 1.0″ and beyond.

Although various embodiments that incorporate the teachings of the present invention have been shown and described in detail herein, those skilled in the art can readily devise many other varied embodiments that still incorporate these teachings. The scope of the invention should therefore be determined not with reference to the above description, but instead should be determined with reference to the appended claims along with their full scope of equivalents.

What is claimed is:

1. A screwdriver shank having a non-slip tip disposed at an end of the shank wherein:
a distal end of the tip is adapted to fit into a slot having a predetermined width;
an edge of the tip, along the distal end, is a straight line;
the distal end of the tip is rotated with respect to a proximal end of the tip; and
gripping lines are disposed on one or more surfaces of the tip.

2. The screwdriver shank of claim 1 wherein a configuration of the gripping lines on a surface comprises one of: horizontal, parallel, straight gripping lines; a grid of horizontal, parallel and vertical, parallel, straight gripping lines; arcs curving downward toward the tip; vertical, parallel, straight gripping lines; arcs curving upward away from the tip; a grid of first parallel, straight gripping lines disposed at a first angle to vertical and second parallel, straight gripping lines disposed at a second angle to vertical; horizontal, wavy lines; overlapping sets of arcs curving upward away from and downward toward the tip, respectively; miniature circle gripping lines; triangular rip gripping lines; triangular gripping lines; three groups of gripping lines, two groups of matching outside angles with a third group of having inverted triangle centers; a pattern of converging curved gripping lines; vertical wavy gripping lines; a group of distorted oval-shaped gripping lines; and square chain gripping lines.

3. A screwdriver shank having a non-slip tip disposed at an end of the shank wherein:
a distal end of the tip is adapted to fit into a slot having a predetermined width; and
an edge of the tip, along the distal end, comprises two or more straight line segments wherein two of the line segments are disposed at non-zero angles with respect to each other.

4. The screwdriver shank of claim 3 wherein the distal end of the tip is rotated with respect to a proximal end of the tip.

5. The screwdriver shank of claim 3 wherein gripping lines are disposed on one or more surfaces of the tip.

6. The screwdriver shank of claim 5 wherein a configuration of the gripping lines on a surface comprises one of: horizontal, parallel, straight gripping lines; a grid of horizontal, parallel and vertical, parallel, straight gripping lines; arcs curving downward toward the tip; vertical, parallel, straight gripping lines; arcs curving upward away from the tip; a grid of first parallel, straight gripping lines disposed at a first angle to vertical and second parallel, straight gripping lines disposed at a second angle to vertical; horizontal, wavy lines; overlapping sets of arcs curving upward away from and downward toward the tip, respectively; miniature circle gripping lines; triangular rip gripping lines; triangular gripping lines; three groups of gripping lines, two groups of matching outside angles with a third group of having inverted triangle centers; a pattern of converging curved gripping lines; vertical wavy gripping lines; a group of distorted oval-shaped gripping lines; and square chain gripping lines.

7. The screwdriver shank of claim 3 wherein the two or more straight line segments are three straight line segments.

8. A screwdriver shank having a non-slip tip disposed at an end of the shank wherein:
a distal end of the tip is adapted to fit into a slot having a predetermined width; and
an edge of the tip, along the distal end, comprises one or more curved segments.

9. The screwdriver shank of claim 8 wherein the distal end of the tip is rotated with respect to a proximal end of the tip.

10. The screwdriver shank of claim 8 wherein gripping lines are disposed on one or more surfaces of the tip.
